(19) United States
(12) Patent Application Publication
(10) Pub. No.: US 2026/0131788 A1
(43) Pub. Date: May 14, 2026

(54) OVERTAKING FOR VEHICLE COMBINATIONS

(71) Applicant: VOLVO TRUCK CORPORATION, Göteborg (SE)

(72) Inventors: Esteban GELSO, Västra Frölunda (SE); Maliheh Sadeghi Kati, Öjersjö (SE); Leo Laine, Göteborg (SE)

(73) Assignee: VOLVO TRUCK CORPORATION, Göteborg (SE)

(21) Appl. No.: 19/382,839

(22) Filed: Nov. 7, 2025

(30) Foreign Application Priority Data
Nov. 12, 2024 (EP) 24212364.4

(51) Int. Cl. B60W 30/18; B60W 30/04

(52) U.S. Cl. CPC B60W 30/18163; B60W 30/04; B60W 2300/145; B60W 2520/125; B60W 2520/14; B60W 2554/402

(57) ABSTRACT

A computer system and computer-implemented method are disclosed for identifying an overtaking opportunity for a host vehicle combination comprising a tractor unit and at least one trailing unit. The computer system has processing circuitry to acquire parameters of at least one vehicle preceding the host vehicle combination; determine a visible range, R, from the host vehicle combination for an upcoming section of a route; and identify an overtaking opportunity by determining that the host vehicle combination can perform an overtaking manoeuvre over the at least one preceding vehicle within the visible range, R, in a stable manner based on the acquired parameters of the at least one preceding vehicle.

### TECHNICAL FIELD

The disclosure relates generally to vehicle control. In particular aspects, the disclosure relates to overtaking for vehicle combinations. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In vehicle motion management, control of multi-unit vehicle combinations is challenging due to the complexity of coordinating and manoeuvring multiple vehicle units together. Unlike single vehicles, these vehicle combinations require careful consideration of each vehicle unit's dynamic and the interaction between them. These multi-unit configurations often exhibit complex interactions, such as inter-vehicle communication, varying states, and dynamic behaviours.

Conventional navigation systems and advanced driver-assistance systems (ADAS) are often insufficient in addressing the specific needs of multi-unit vehicle combinations, leaving drivers with limited support and increased risk of accidents or damage to property and cargo. Existing solutions may not properly account for the dimensions and handling characteristics of these vehicles. This is a particular issue during overtaking manoeuvres, where driver visibility is also a concern.

It is therefore desired to provide systems, methods and other approaches for vehicle motion management that attempt to resolve or at least mitigate one or more of these issues.

### SUMMARY

This disclosure provides systems, methods and other approaches for determining an overtaking opportunity for a vehicle combination. In particular, it is proposed to determine opportunities along an upcoming section of road where a host vehicle combination can perform an overtaking manoeuvre on at least one preceding vehicle within a visible range from the host vehicle combination and in a stable manner. This can be achieved by determining if a time or distance for the host vehicle combination to perform a stable overtaking manoeuvre on a preceding vehicle is less than a time for the host vehicle combination to travel the visible range. Alternatively, this can be achieved by determining if a stability measure of an overtaking manoeuvre performed within the visible range is above a threshold stability. A stable overtaking manoeuvre can be defined by the amount of rearward amplification, rollover risk, or off-tracking experienced by the host vehicle combination during the overtaking manoeuvre. For example, the time or distance for the host vehicle combination to perform a stable overtaking manoeuvre may be longer in order to reduce trailer oscillations.

In this way, overtaking opportunities for the vehicle combination can be determined that enable stable overtaking of a preceding vehicle. The overtaking opportunities can be determined based on one or more of route parameters (such as turn radii, road slope, and surface friction), vehicle combination parameters (such as length, width, mass, maximum velocity, and maximum acceleration, combination configuration, type of coupling, and load distribution), preceding vehicle parameters (such as length, width, and velocity), and environmental parameters (such as weather conditions and traffic). This ensures that appropriate overtaking opportunities are determined based on current conditions. The determination of overtaking opportunities can be used in a selection between two or more routes based on the availability and stability of overtaking possibilities.

According to a first aspect of the disclosure, there is provided computer system for identifying an overtaking opportunity for a host vehicle combination comprising a tractor unit and at least one trailing unit, the computer system comprising processing circuitry configured to: acquire parameters of at least one vehicle preceding the host vehicle combination; determine a visible range from the host vehicle combination for an upcoming section of a route; and identify an overtaking opportunity by determining that the host vehicle combination can perform an overtaking manoeuvre over the at least one preceding vehicle within the visible range in a stable manner based on the acquired parameters of the at least one preceding vehicle

The first aspect of the disclosure may seek to identifying overtaking opportunities for the vehicle combination that enable stable overtaking of a preceding vehicle. The overtaking opportunities can be determined based on one or more of route parameters, vehicle combination parameters, preceding vehicle parameters, and environmental parameters, which ensures that appropriate overtaking opportunities are determined based on current conditions.

Optionally in some examples, including in at least one preferred example, the processing circuitry is configured to: determine a first time or longitudinal distance for the host vehicle combination to travel the visible range; determine a second time or longitudinal distance for the host vehicle combination to perform an overtaking manoeuvre on the at least one preceding vehicle in a stable manner, based on the acquired parameters of the at least one preceding vehicle; and determine that the second time or longitudinal distance is less than the first time or longitudinal distance. A technical benefit may include that a first approach is provided for identifying overtaking opportunities for the vehicle combination that enable stable overtaking of a preceding vehicle.

Optionally in some examples, including in at least one preferred example, the second time or longitudinal distance comprises: a time or longitudinal distance to make a first lateral movement beyond the width of the at least one preceding vehicle, a time or longitudinal distance to make a longitudinal movement past the length of the at least one preceding vehicle, and a time or longitudinal distance to make a second lateral movement in an opposite direction to the first lateral movement. A technical benefit may include that a possible overtaking manoeuvre can be assessed based on different stages of motion, which can be assessed individually in terms of their stability.

Optionally in some examples, including in at least one preferred example, the processing circuitry is configured to: determine a stability measure of an overtaking manoeuvre by the host vehicle combination over the at least one preceding vehicle within the visible range based on the acquired parameters of the at least one preceding vehicle; and determine that the stability measure is above a threshold stability. A technical benefit may include that a second approach is provided for identifying overtaking opportunities for the vehicle combination that enable stable overtaking of a preceding vehicle.

Optionally in some examples, including in at least one preferred example, the parameters of the at least one preceding vehicle comprise one or more of a longitudinal velocity, a longitudinal acceleration, a lateral velocity, a lateral acceleration, a length, a width, and a type of the at least one preceding vehicle. A technical benefit may include that a detailed assessment of the motion of the preceding vehicle can be taken into account when determining the stability of a possible overtaking manoeuvre.

Optionally in some examples, including in at least one preferred example, the processing circuitry is configured to determine that the host vehicle combination can perform an overtaking manoeuvre over the at least one preceding vehicle within the visible range in a stable manner based on at least one of one or more route parameters, one or more host vehicle combination parameters, and one or more environmental parameters. A technical benefit may include that a detailed assessment of the motion of the current conditions affecting motion of the vehicle combination can be taken into account when determining the stability of a possible overtaking manoeuvre.

Optionally in some examples, including in at least one preferred example, an overtaking manoeuvre performed in a stable manner comprises one or more of a rearward amplification, a rollover risk, and an off-tracking of the host vehicle combination being below a respective threshold value. A technical benefit may include that different measures of stability can be taken into account when determining the stability of a possible overtaking manoeuvre.

Optionally in some examples, including in at least one preferred example, the rearward amplification is defined as: the ratio of the maximum absolute yaw rate of a trailing unit of the host vehicle combination to the maximum absolute yaw rate of a tractor unit of the host vehicle combination; or the ratio of the maximum absolute lateral acceleration of a trailing unit of the host vehicle combination to the maximum absolute lateral acceleration of a tractor unit of the host vehicle combination. A technical benefit may include that a quantitative assessment of the stability of a manoeuvre can be provided.

Optionally in some examples, including in at least one preferred example, the processing circuitry is further configured to determine one or more control inputs for the host vehicle combination to perform the overtaking manoeuvre. A technical benefit may include that the vehicle combination can be controlled to perform an overtaking manoeuvre at an appropriate time and/or location and in a stable manner.

Optionally in some examples, including in at least one preferred example, the processing circuitry is further configured to: determine that a stability measure during performance of the overtaking manoeuvre by the host vehicle combination is below a threshold stability; and update the one or more control inputs such that stability measure is above the threshold stability. A technical benefit may include that control of the vehicle combination can be adjusted to take into account any changes in the stability of the manoeuvre, for example due to changes in route geometry, motion of the host vehicle, and/or environmental conditions.

Optionally in some examples, including in at least one preferred example, the processing circuitry is further configured to update the one or more control inputs during performance of the overtaking manoeuvre by the host vehicle combination based on updated parameters of the at least one preceding vehicle. A technical benefit may include that control of the vehicle combination can be adjusted to take into account any changes in the stability of the manoeuvre, for example due to changes in the motion of the at least one preceding vehicle.

According to a second aspect of the disclosure, there is provided a vehicle comprising the system of the first aspect. The second aspect of the disclosure may seek to provide a vehicle capable of identifying overtaking opportunities that enable stable overtaking of a preceding vehicle.

According to a third aspect of the disclosure, there is provided a computer-implemented method for determining an overtaking opportunity for a host vehicle combination comprising a tractor unit and at least one trailing unit, the computer-implemented method comprising: acquiring, by processing circuitry of a computer system, parameters of at least one vehicle preceding the host vehicle combination; determining, by the processing circuitry, a visible range from the host vehicle combination for an upcoming section of a route; and identifying, by the processing circuitry, an overtaking opportunity by determining that the host vehicle combination can perform an overtaking manoeuvre over the at least one preceding vehicle within the visible range in a stable manner based on the acquired parameters of the at least one preceding vehicle.

The third aspect of the disclosure may seek to identify overtaking opportunities for the vehicle combination that enable stable overtaking of a preceding vehicle. The overtaking opportunities can be determined based on one or more of route parameters, vehicle combination parameters, preceding vehicle parameters, and environmental parameters, which ensures that appropriate overtaking opportunities are determined based on current conditions.

According to a fourth aspect of the disclosure, there is provided a computer program product comprising program code for performing, when executed by processing circuitry, the computer-implemented method of the third aspect. The fourth aspect of the disclosure may seek to enable new vehicles and/or legacy vehicles to be conveniently configured, by software installation/update, to identify overtaking opportunities that enable stable overtaking of a preceding vehicle.

According to a fifth aspect of the disclosure, there is provided a non-transitory computer-readable storage medium comprising instructions, which when executed by processing circuitry, cause the processing circuitry to perform the computer-implemented method of the third aspect. The fifth aspect of the disclosure may seek to enable new vehicles and/or legacy vehicles to be conveniently configured, by software installation/update, to identify overtaking opportunities that enable stable overtaking of a preceding vehicle.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a top view of a vehicle combination according to an example of the disclosure.

FIG. 2 illustrates a route along which a vehicle combination may travel according to an example of the disclosure.

FIG. 3 illustrates a section of road according to an example of the disclosure, such as a section of the route shown in FIG. 2.

FIG. 4 is a flow chart of a computer-implemented method according to an example of the disclosure.

FIG. 5 is a flow chart of a computer-implemented method according to another example of the disclosure.

FIG. 6 is a flow chart of a computer-implemented method according to another example of the disclosure.

FIG. 7 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

In vehicle motion management, control of multi-unit vehicle combinations is challenging due to the complexity of coordinating and manoeuvring multiple vehicle units together. These multi-unit configurations often exhibit complex interactions, such as inter-vehicle communication, varying states, and dynamic behaviours. Existing solutions may not properly account for the dimensions and handling characteristics of these vehicles, leaving drivers with limited support and increased risk of accidents or damage to property and cargo. This is a particular issue during overtaking manoeuvres, where driver visibility is also a concern.

To remedy this, systems, methods and other approaches for determining an overtaking opportunity for a vehicle combination. In particular, it is proposed to determine opportunities along an upcoming section of road where a host vehicle combination can perform an overtaking manoeuvre on at least one preceding vehicle within a visible range from the host vehicle combination and in a stable manner. This can be achieved by determining if a time or distance for the host vehicle combination to perform a stable overtaking manoeuvre on a preceding vehicle is less than a time for the host vehicle combination to travel the visible range. Alternatively, this can be achieved by determining if a stability measure of an overtaking manoeuvre performed within the visible range is above a threshold stability. A stable overtaking manoeuvre can be defined by the amount of rearward amplification, rollover risk, or off-tracking experienced by the host vehicle combination during the overtaking manoeuvre. For example, the time or distance for the host vehicle combination to perform a stable overtaking manoeuvre may be longer in order to reduce trailer oscillations.

In this way, overtaking opportunities for the vehicle combination can be determined that enable stable overtaking of a preceding vehicle. The overtaking opportunities can be determined based on one or more of route parameters (such as turn radii, road slope, and surface friction), vehicle combination parameters (such as length, width, mass, maximum velocity, and maximum acceleration, combination configuration, type of coupling, and load distribution), preceding vehicle parameters (such as length, width, and velocity), and environmental parameters (such as weather conditions and traffic). This ensures that appropriate overtaking opportunities are determined based on current conditions.

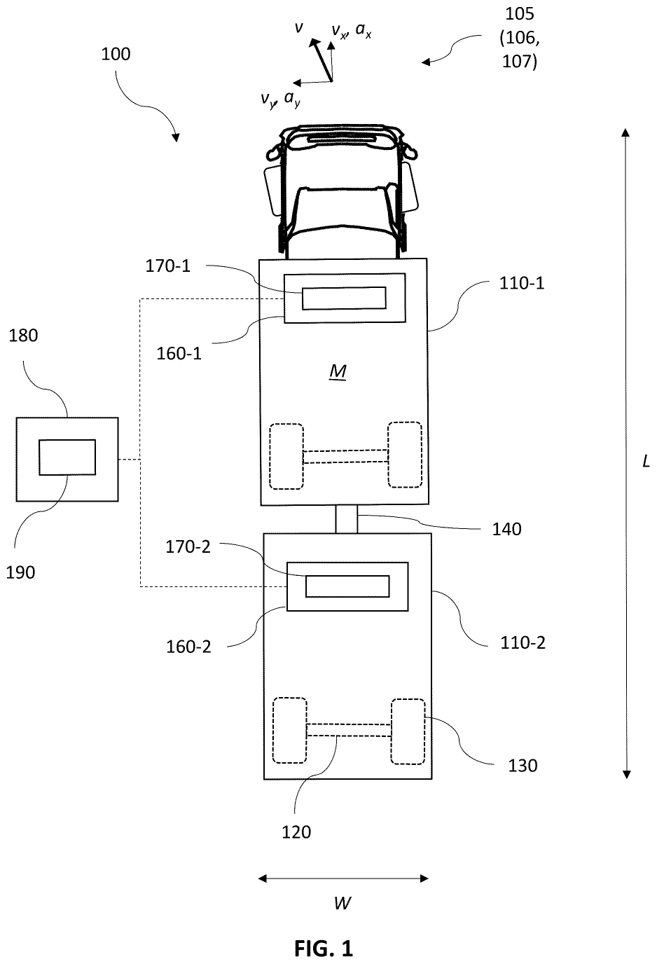

FIG. 1 schematically shows a top view of an example vehicle combination 100 of the type considered in this disclosure. The vehicle combination 100 comprises a number of units 110, including a tractor unit 110-1 and a trailing unit 110-2. Whilst a single trailing unit 110-2 is shown, it will be appreciated that the vehicle combination 100 may comprise further trailing units. This gives rise to different types and designations of vehicle combinations. The vehicle combination 100 shown in FIG. 1 is an example of a truck, however the systems and methods disclosed herein can be used with any suitable form of vehicle combination 100, such as trucks, buses, and the like.

A tractor unit, such as the tractor unit 110-1, is generally the foremost unit in a vehicle combination 100, and may comprise the cabin for the driver, including steering controls, dashboard displays and the like. Generally, the tractor unit 110-1 is used to provide propulsion power/torque for the vehicle combination 100. In the example of FIG. 1, the tractor unit 110-1 may also be used to store goods that are being transported by the vehicle combination 100. A tractor unit may also be referred to as a truck.

A trailing unit, such as the trailing unit 110-2, is generally used to store goods that are being transported by the vehicle combination 100. A trailing unit may be a truck, trailer, dolly and the like. A trailing unit may also provide propulsion to the vehicle combination 100. In vehicle combinations such as that shown in FIG. 1, vehicle motion management may be available on a unit level to receive requests from a manual or virtual driver to coordinate the propulsion, braking and steering.

Each unit 110 comprises a number of axles 120, each having a number of wheels 130. It will be appreciated that any suitable number of axles 120 may be provided on the respective units 110. A trailing unit 110-2 without a front axle is known as a semi-trailer. It will also be appreciated that any number of the tractor axles and/or trailer axles may be driven axles, including zero (i.e. one of the units 110 may include at least one driven axle while the other does not). It will also be appreciated that any suitable number of the tractor axles and/or trailer axles may be steered axles.

The units 110 are connected by a coupling 140. The coupling 140 may be of any type known in the art, such as a fifth-wheel (kingpin) coupling, a drawbar coupling, a ball and spoon coupling, a converter dolly, and the like.

The vehicle combination 100 may comprise one or more sources of propulsion. For example, one or more of the units 110 may comprise one or more electrical machines such as electric motors. The electrical machines are configured to drive, e.g. provide torque and/or steering to, one or more axles or individual wheels of a unit 110. The electrical machines of a unit 110 can supply either a positive (propulsion) or negative (braking) force.

Each unit 110 may comprise one or more batteries configured to provide power to the electrical machines. A vehicle combination 100 that uses only battery power is a battery electric vehicle (BEV). In some examples, electric motors may also be operated as generators, in order for the electric motors to generate braking force when required. The use of electrical machines to supply a negative force is known as regenerative braking. The energy recovered from regenerative braking can be stored in the batteries, and so regenerative braking may generally be preferred over using service brakes.

In some examples, for example in the case of a hybrid electric vehicle (HEV), a unit 110, most often a tractor unit 110-1, may also include another source of propulsion, for example an internal combustion engine (ICE). The vehicle combination 100 also comprises a drivetrain to deliver mechanical power from the propulsion source (the electrical machines or the ICE) to the wheels. All units 110 may provide propulsion to the vehicle combination 100. In the examples discussed herein, the vehicle combination 100 may be a BEV or an HEV.

Furthermore, each unit 110 may comprise one or more sets of service brakes. The service brakes of a unit 110 can supply a negative (braking) force. The service brakes may be, for example, frictional brakes such as pneumatic brakes. Pneumatic brakes use a compressor to fill the brake with air, which may be powered by the batteries. In some examples, the brakes may be electro-mechanical brakes or hydraulic brakes.

The ICE, electrical machines and service brakes are considered as actuators of the vehicle combination 100. Other actuators may also be present. For example, steering actuators, such as steering servo arrangements, may be provided, and may be implemented as electro-hydraulic actuators. It will be appreciated that each axle and/or wheel may have an associated electrical machine, set of service brakes, and/or set of steering actuators.

FIG. 1 also shows parameters of the vehicle combination 100, collectively 105. Examples of parameters 105 of the vehicle combination 100 may include motion parameters 106 and structural parameters 107. Examples of motion parameters 106 of the vehicle combination 100 may include, for example, one or more of a velocity v (including a longitudinal velocity vₓ and/or a lateral velocity v_{y}), a longitudinal acceleration aₓ, a lateral acceleration a_{y}, a propulsion power/torque, and a braking power/torque. The motion parameters 106 may also have an associated capability, for example maximum and/or minimum values of velocity, acceleration and/or power/torque. The motion parameters 106 may also be defined on a unit basis. For example, each unit 110 may have its own velocity and acceleration. Examples of structural parameters 107 of the vehicle combination 100 may include, for example, a length L, a width W, and a mass M, of the vehicle combination 100. The structural parameters 107 may also be defined on a unit basis. For example, each unit 110 may have its own length, width, and mass. This may additionally allow a load distribution across the units 110 of the vehicle combination 100 to be determined, including a centre of gravity (CoG) in the x, y, and/or z directions. Each unit 110 may also have an associated tyre cornering stiffness, yaw moment of inertia, and axle configuration (e.g., steered/liftable/driven axles in each unit 110).

In the example of FIG. 1, the vehicle combination 100 includes a set of controllers 160 comprising processing circuitry 170. The controllers 160 are configured to control components of the vehicle combination 100, for example the electrical machines, the batteries, and the service brakes. In the example of FIG. 1, the vehicle combination 100 includes a controller 160 for each respective unit 110, although it will be appreciated that any suitable number of controllers 160 may be present, and that the controllers 160 may be communicatively coupled with each other. The controllers 160 together form a distributed control allocation system for the vehicle combination 100. In this system, the control allocation may be performed on multiple levels, i.e. first on a level of the vehicle combination 100 as a whole, and then on a level of each vehicle unit 110 individually. Vehicle motion management may therefore be available on a unit level to receive requests from a manual or virtual driver to coordinate the propulsion, braking and steering of the vehicle combination 100. The controllers 160 may be microcontrollers.

The controllers 160 may receive control signals from a global controller 180 comprising processing circuitry 190. The global controller 180 may be a vehicle control unit configured to perform various vehicle (unit) control functions, such as vehicle motion management. The global controller 180 may be local to the vehicle combination 100. For example, the computer system 180 may be implemented in combination with one of the controllers 160, often the controller 160-1 of the tractor unit 110-1. In this case, the controller 160-1 of the tractor unit 110-1 may be considered as the global controller configured to determine control inputs for each unit 110. Alternatively, the global controller 180 may be a remote system implemented at a distance from the vehicle combination 100. In this example, the global controller 180 may be communicatively coupled to one or more of the controllers 160. The global controller 180 may be communicatively coupled to the controller(s) 160 in any suitable way, for example via a circuit or any other wired, wireless, or network connection known in the art. Furthermore, the communicative coupling may be implemented as a direct connection between the controller(s) 160 and the global controller 180, or may be implemented as a connection via one or more intermediate entities.

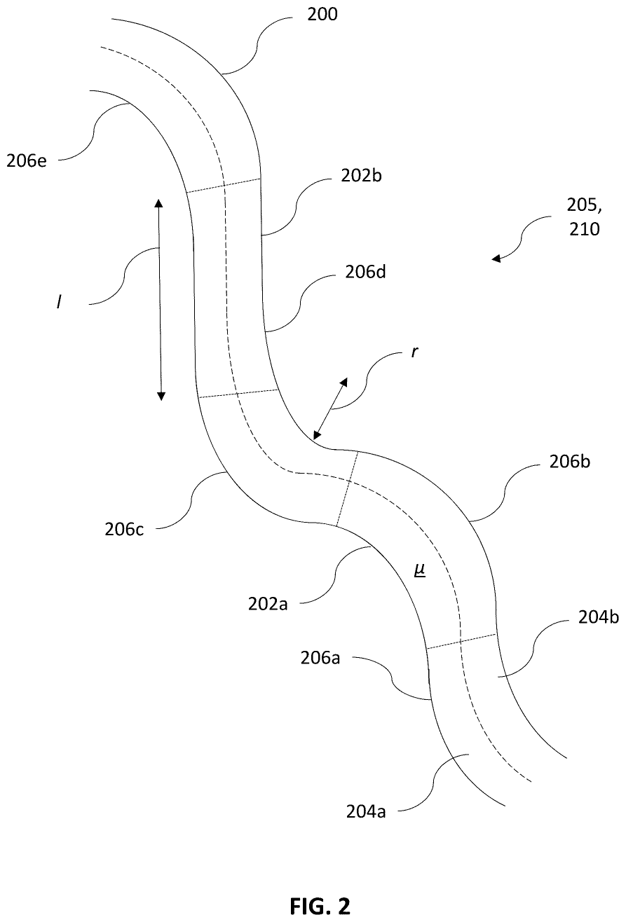

FIG. 2 illustrates a route 200 along which a vehicle combination 100 may travel. The route 200 may be bounded by verges or shoulders 202a-b and comprise a number of lanes 204a-b. While two lanes 204a-b are shown in FIG. 2, it will be appreciated that more or fewer lanes may be present. The route 200 may be characterised by route parameters 205 such as one or more curve radii r, a surface friction μ, a gradient in a longitudinal and/or lateral direction, and/or a speed limit. The route 200 may be divided into a number of sections 206a-e. Each section 206a-e may have its own respective route parameters 205, including a section length l. Whilst a curved path is shown in FIG. 2, it will be appreciated that the approaches disclosed herein are applicable to any suitable operation of the vehicle combination 100, including straight-line driving. The route 200 or sections 206a-e may have their own respective environmental parameters 210, such as traffic and weather conditions.

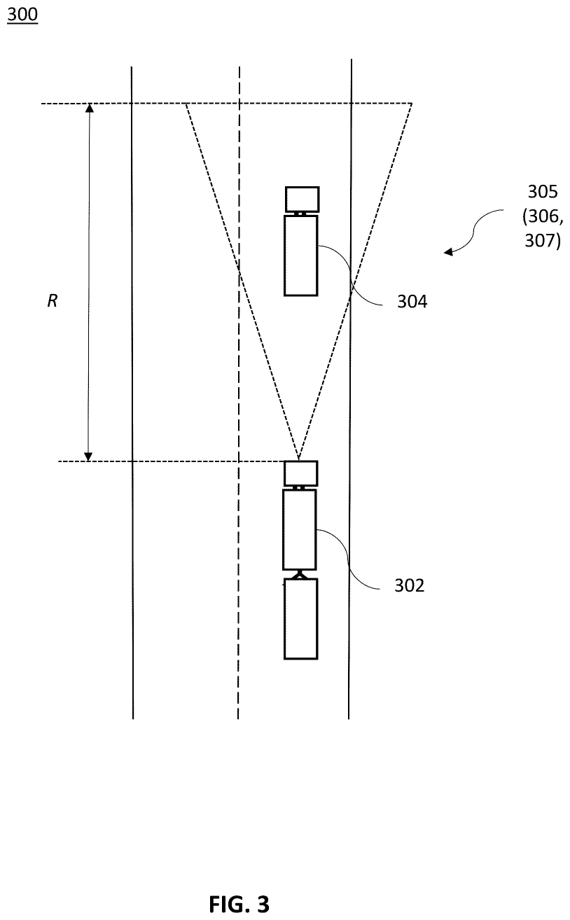

FIG. 3 illustrates a section 300 of road, such as a section 206a-e of the route 200 shown in FIG. 2. The section 300 of route is being travelled by a vehicle combination 302, hereafter referred to as a host vehicle combination 302. The host vehicle combination 302 may be, for example, a vehicle combination 100 as described in relation to FIG. 1. A visible range R may be defined from the host vehicle combination 302.

The visible range R may be determined in any suitable way. For example, the visible range R may be defined by the visibility range of a driver of the host vehicle combination 302. In this case, a default value could be used corresponding to an average visibility range of a human, or a minimum legal visibility range for a driver. Alternatively, a driver may input a personal value for their own visibility range. In some examples, the visibility range R may be determined based on apparatus associated with the vehicle combination 302. For example, a (e.g. forward-facing) camera, radar, or LIDAR apparatus of the host vehicle combination 302 could be used to provide the visible range R using techniques known in the art. In some examples, other vehicles or roadside sensors that form part of an intelligent transportation system could be used to provide the visible range R for different sections 206a-e of the route 200. The visible range R may be affected by route parameters 205 and/or environmental parameters 210 associated with the section 300 of route. For example, if a curve is upcoming along the route around which the driver or camera cannot see, the visible range R may be limited. In some examples, mapping technology such as GPS may be used to determine any blind corners (caused by, e.g., steep inclines and curves) or obstacles along the route 200 and the visible range R may be determined based on a current location of the combination 302. Similarly, if weather conditions such as fog, rain, daylight, sun position, and the like limit visibility, the visible range R may be affected. In some examples, a default value can be set and then updated based on one or more of the factors discussed above. In some examples, a safety margin may be applied to the visible range R, which may be based on the speed of the host vehicle combination 302 or a preceding vehicle.

FIG. 3 also shows a vehicle 304 preceding the host vehicle combination 302, hereafter referred to as a preceding vehicle 304. The preceding vehicle 304 may also be a vehicle combination, for example, a vehicle combination 100 as described in relation to FIG. 1. The preceding vehicle 304 may also be any other type of vehicle, such as trucks, buses, construction equipment, and personal vehicles such as cars, vans, or motorbikes. The preceding vehicle 304 may also be described by parameters 305 including motion parameters 306 and structural parameters 307, such as one or more of a velocity v (including a longitudinal velocity vₓ and/or a lateral velocity v_{y}), a longitudinal acceleration aₓ, a lateral acceleration a_{y}, a propulsion power/torque, a braking power/torque, a length L, a width W, and a mass M. The motion parameters 306 may also have an associated capability, for example maximum and/or minimum values of velocity, acceleration and/or power/torque.

At a certain point, it may desired for the host vehicle combination 302 to overtake the preceding vehicle 304, or indeed two or more preceding vehicles. This may incorporate the longitudinal motion of the host vehicle combination 302 and the preceding vehicle 304, route parameters 205 such as upcoming turns, speed limits, and surface friction, and environmental parameters 210 such as traffic and weather conditions. Conventional navigation systems and ADASs are often insufficient in addressing the specific needs of multi-unit vehicle combinations such as the host vehicle combination 302.

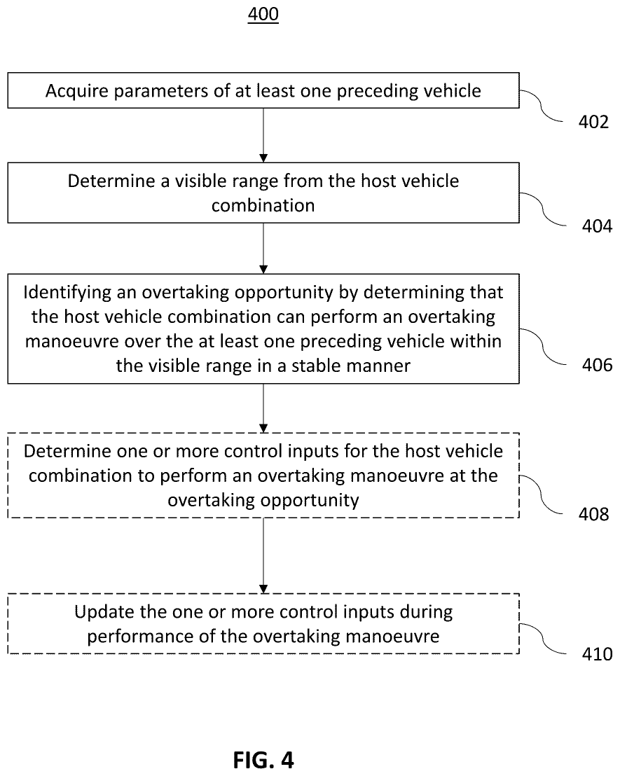

FIG. 4 is a flow chart of a computer-implemented method 400 according to an example. The method 400 is for determining an overtaking opportunity for a host vehicle combination, such as the host vehicle combination 302. The method 400 enables overtaking opportunities to be determined that enable stable overtaking of a preceding vehicle. The overtaking opportunities can be determined based on current conditions, and can be used in a selection between two or more routes based on the availability and stability of overtaking possibilities. The method 400 may be implemented by processing circuitry of a computer system (e.g., the processing circuitry 170 of the controller(s) 160, or the processing circuitry 190 of the global controller 180 described in relation to FIG. 1).

At 402, parameters 305 of at least one preceding vehicle 304 are acquired. As discussed above, the parameters 305 of a preceding vehicle 304 may comprise one or more of a longitudinal velocity vₓ, a lateral velocity v_{y}, a lateral acceleration, a longitudinal acceleration aₓ, a lateral acceleration a_{y}, a propulsion power/torque, a braking power/torque, a length L, a width W, a mass M, and a type of the preceding vehicle 304. The motion parameters 306 may also have an associated capability, for example maximum and/or minimum values of velocity, acceleration and/or power/torque. The motion parameters 306 of the preceding vehicle 304 may be measured values (measured, for example, using a suitable apparatus on the host vehicle combination 302), received values (received, for example, from a fleet management platform associated with the host vehicle combination 302 and the preceding vehicle 304), or predicted values (received, for example, based on a known destination and/or turning signals of the preceding vehicle 304). The structural parameters 307 may be acquired, for example, by measurement (e.g. using a suitable apparatus on the host vehicle combination 302) or by querying a database containing vehicle information, for example corresponding to license plate numbers of different vehicles or based on a vehicle-type designation by a driver or operator (e.g. a remote operator) of the host vehicle combination 302.

The acquisition of preceding vehicle parameters 305 at 402 may be triggered in a number of different ways. For example, the one or more preceding vehicles 304 may be detected using image recognition techniques known in the art, based on images from a camera of the host vehicle combination 302. In some examples, a driver or operator (e.g. a remote operator) of the host vehicle combination 302 may activate an overtaking mode, for example by requesting an overtaking manoeuvre over a preceding vehicle 304, designating a vehicle type, speed, etc. of the preceding vehicle 304, and/or specifying a distance within which the overtaking manoeuvre should be performed.

At 404, a visible range R from the host vehicle combination 302 is determined. As discussed above, the visible range R may be defined by the visibility range of a driver of the host vehicle combination 302 or the visibility range of a (e.g. forward-facing) camera of the host vehicle combination 302. The visible range R may be affected by route parameters 205 and/or environmental parameters 210 associated with an upcoming section of a route, such as blind corners, weather conditions, and the like.

The visible range R is determined for an upcoming section of a route. This may correspond to the remainder of a section of route in which the host vehicle combination 302 is currently travelling, such as the section 300 shown in FIG. 3, or one or more sections further along the route. For example, referring to FIG. 2, if the host vehicle combination 302 is currently travelling in section 204a, a visible range R is determined for the remainder of section 204a and/or for one or more of sections 204b-e.

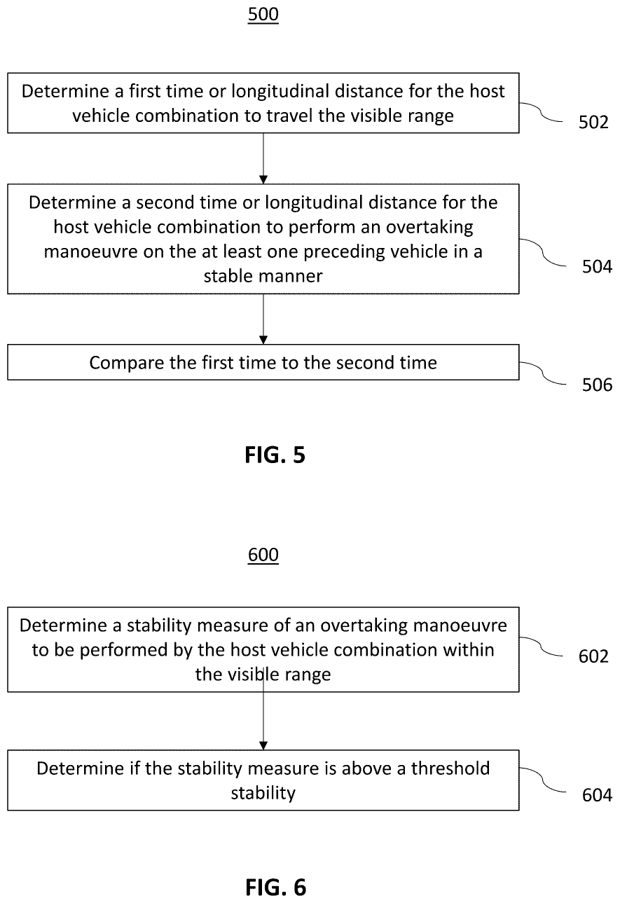

At 406, an overtaking opportunity is determined by determining that the host vehicle combination 302 can perform an overtaking manoeuvre over the at least one preceding vehicle 304 within the visible range R in a stable manner. In a first approach, one or more stable overtaking manoeuvres are modelled, and a corresponding time and/or distance to perform the manoeuvre is determined. The time and/or distance to perform the stable overtaking manoeuvre is then compared to the visible range R to determine if the manoeuvre can be performed within the visible range R. In a second approach, one or more overtaking manoeuvres are modelled within the visible range R, and a corresponding stability measure for the host vehicle combination 302 is determined. It is then determined if the stability measure meets a threshold stability. This will be explained in more detail in relation to FIGS. 5 and 6.

By determining that the host vehicle combination 302 can perform a stable overtaking manoeuvre within the visible range R, it can be ensured that only overtaking opportunities where there is visibility of any obstacles hazards are determined. In this way, overtaking opportunities are not determined that would involve entering road sections that cannot yet be seen, such as due to blind corners, poor weather conditions, and the like.

The output of 406 comprises one or more overtaking opportunities for the host vehicle combination 302. An overtaking opportunity comprises a location along a route at which to overtake a preceding vehicle 304. The overtaking opportunity may include corresponding manoeuvre parameters (i.e. how the manoeuvre should be performed at the associated location), and/or a probability or risk of success of the manoeuvre.

The modelling at 406 may be performed using any suitable vehicle model. The vehicle model includes one or more parameters 105 of the host vehicle combination 302. These parameters 105 may include motion parameter capabilities, for example maximum and/or minimum values of velocity, acceleration and/or power/torque, and/or structural parameters 107 such as a length L, a width W, a mass M, a type, a configuration (e.g. number of units 110) and a load distribution (e.g. CoG) of the host vehicle combination 302. These parameters 105 may also be defined on a unit basis, and may include the wheelbase of each unit 110, a type of coupling 140 between units 110, a tyre cornering stiffness, and axle configuration (e.g., steered/liftable/driven axles in each unit 110). The vehicle model may be using any suitable vehicle model known in the art, such as a single-track vehicle combination.

The modelling at 406 may be performed based on one or more route parameters 205, such as curve radii r, a surface friction μ, a gradient in a longitudinal and/or lateral direction, and/or a speed limit. The modelling at 406 may be performed based on one or more environmental parameters 210, such as traffic information (e.g. obtained from historical data, and/or from current traffic data) and weather conditions (e.g. obtained from weather forecasts) that may affect motion of the host vehicle combination 302.

The stability of an overtaking manoeuvre can be assessed based on one or more stability measures. The stability measures provide an assessment of whether the behaviour of the host vehicle combination 302 during the overtaking manoeuvre can be considered safe and/or stable. In particular, the stability measures may include one or more of a rearward amplification, a rollover risk, and an off-tracking of the host vehicle combination 302. For an overtaking manoeuvre to be considered stable, it is desired that one or more of these measures is below a threshold.

Rearward amplification is a phenomenon that occurs in vehicle combinations, where movements of the trailing units become exaggerated compared to the movements of the tractor unit. This can occur when there is lateral motion of the vehicle combination, for example during when navigating turns or overtaking maneuvers. As the tractor unit moves laterally, the motion is transmitted to the trailing units, often with an amplifying effect. The further back a trailer unit is from the tractor unit (i.e., in multi-trailer configurations), the greater the amplification of lateral forces. This can lead to instability or excessive trailer sway, increasing the risk of loss of control or jackknifing. Higher vehicle speed results in a higher rearward amplification. In most articulated vehicles, the highest rearward amplification value occurs around 0.3-0.4 Hz of driver steering input. Typically, the last trailing unit has the highest rearward amplification.

In some examples, a measure of the rearward amplification for a trailing unit 110-2 is defined as the ratio of the maximum absolute yaw rate of the trailing unit 110-2 to the maximum absolute yaw rate of the tractor unit 110-1 during an overtaking manoeuvre. In some examples, a measure of the rearward amplification for a trailing unit 110-2 is defined as the ratio of the maximum absolute lateral acceleration of the trailing unit 110-2 to the maximum absolute lateral acceleration of the tractor unit 110-1 during an overtaking manoeuvre. The ideal value is one, which means no rearward amplification. The rearward amplification can be determined for one or more, including all trailing units of the host vehicle combination 302.

The determined value(s) of rearward amplification can then be compared to a threshold amount of rearward amplification that is considered stable. If the determined values are below the threshold, the overtaking manoeuvre can be considered stable in terms of rearward amplification. In some examples, only the highest value of rearward amplification (e.g. that for the rearmost unit) may be compared to the threshold. As discussed above, the most desirable value for rearward amplification is 1, which indicates no amplification. This can be used as a basis for setting a threshold based on factors such as vehicle configuration, road conditions (e.g. surface friction), road type, manoeuvre type, vehicle stability functions, and the like. For example, for a lane change for a vehicle combination having more than one trailing unit, a threshold rearward amplification between 1.1 and 1.3 may be acceptable. A lower threshold may be used for lower friction surfaces.

Rollover refers to a situation one or more units of a vehicle combination overturns, usually during sharp turns or high-speed manoeuvres. This can occur when the lateral forces on the trailer (typically from cornering or swerving) are increased. The taller and heavier the load, the higher the CoG, making the unit more susceptible to rollover.

In some examples, a measure of the rollover risk for a unit 110 is defined as the ratio of half the wheelbase of the unit 110 to the CoG height of the unit 110. In some examples, a measure of the rollover risk for a unit 110 can be provided by measuring the lateral acceleration, roll angle, roll rate, and/or normal tyre forces of the unit 110 during an overtaking manoeuvre. The normal forces or load, for example measured or estimated by a suspension system of the unit 110, may also be taken into account. Vehicle rollover stability is usually assessed only in steady state conditions, and the methods available include static stability factor (the ratio of half the track width to height of the center of gravity), tilt table ratio (the tangent of the tilt table angle at which one side of the vehicle wheels lifts off the tilt table), and side pull ratio (the ratio of lateral force to vehicle weight at vehicle center of gravity at which one side of the vehicle's wheels lifts off the ground).

If the determined value(s) of the rollover risk are below a threshold, the overtaking manoeuvre can be considered stable in terms of rollover risk. The methods discussed above can all be presented in terms of a threshold called steady state rollover threshold (SRT). The SRT is defined as a level of lateral acceleration at which a vehicle's axle lifts-off from one side, and can be closely related to tilt table ratio. Suitable values of the SRT may be 0.3 to 0.4 g, which can be adjusted based on factors such as vehicle configuration, road conditions (e.g. surface friction), road type, manoeuvre type, vehicle stability functions, and the like.

Off-tracking is the deviation of (a unit 110 of) a vehicle combination 100 from an intended path. This can be defined as the deviation of the tractor unit 110-1 from an intended path, and/or the deviation of a trailing unit 110-2 from the path of the tractor unit 110-1, particularly when making turns or curves.

In some examples, a measure of the off-tracking of a vehicle combination 100 is defined as the lateral deviation between the path of (the centre of) the front axle of the tractor unit 110-1 and the path of (the centre of) the rearmost axle of the rearmost trailing unit 110-2 during an overtaking manoeuvre. In some examples, a measure of the off-tracking of a vehicle combination 100 is defined as the maximum lateral deviation between the path of (the centre of) the front axle of the tractor unit 110-1 and the path of (the centre of) any axle of the trailing unit(s) 110-2 during an overtaking manoeuvre. If the determined value is below a threshold, the overtaking manoeuvre can be considered stable in terms of off-tracking. The off-tracking threshold may be dependent on factors such as road conditions (e.g. surface friction) and road geometry. For example, a threshold deviation of 0.5 m within lane boundaries may be suitable.

The thresholds used for the respective stability measures may be dependent on parameters such as the number of trailing units 110-2, the mass of the trailing unit 110-2, the speed of the host vehicle combination 302, a type of the host vehicle combination 302, a type of coupling 140 between units 110, environmental parameters 210, and the like. In some examples, different thresholds may be set for different stages of an overtaking manoeuvre (e.g. a first lateral, longitudinal, and second lateral movement as will be discussed in relation to FIG. 5).

At 408, once an overtaking opportunity has been determined, one or more control inputs may be determined for the host vehicle combination 302 to perform an overtaking manoeuvre at the overtaking opportunity. The control inputs may include motion instructions for the host vehicle combination 302, such as a longitudinal velocity vₓ, a lateral velocity v_{y}, a lateral acceleration, a longitudinal acceleration aₓ, a lateral acceleration a_{y}, a propulsion power/torque, and/or a braking power/torque, required for the host vehicle combination 302 to perform an overtaking manoeuvre on the at least one preceding vehicle 304 in a stable manner. The control inputs may include maximum and/or minimum values of the motion instructions. The control inputs may correspond to different stages of the overtaking manoeuvre, such as turning on and indicator, adjusting the vehicle speed, positioning into a target/adjacent lane, and returning to a proper lane once clear of the at least one preceding vehicle 304.

At 410, during performance of the overtaking manoeuvre, the one or more control inputs may be updated. For example, it may be determined during performance of the overtaking manoeuvre that one or more of the stability measures discussed above is or will be below a threshold. In which case, the one or more control inputs may be updated to avoid such a situation. For example, lateral acceleration and/or longitudinal velocity of the host vehicle combination 302 may be limited to avoid an instability. This may include stopping the host vehicle combination 302. In another example, updated parameters 305 of the at least one preceding vehicle 304 may be acquired, which mean that the originally determined control inputs are no longer appropriate. In another example, information regarding traffic (e.g. a vehicle travelling in opposite direction in a two-way road) may be received. Again, the one or more control inputs may be updated to take account of the new scenario.

As discussed above in relation to 406, a first approach to determining an overtaking opportunity involves the modelling of one or more stable overtaking manoeuvres, and comparison of a time and/or distance to perform the manoeuvre is to the visible range R. This explained in relation to FIG. 5, which is a flow chart of a computer-implemented method 500 for determining that the host vehicle combination 302 can perform an overtaking manoeuvre over the at least one preceding vehicle 304 within the visible range R in a stable manner. The method 500 may be implemented by processing circuitry of a computer system (e.g., the processing circuitry 170 of the controller(s) 160, or the processing circuitry 190 of the global controller 180 described in relation to FIG. 1).

At 502, a first time is determined. The first time is the time for the host vehicle combination 302 to travel the visible range R. This may be determined based on a longitudinal velocity of the host vehicle combination 302 (e.g. a current or predicted longitudinal velocity). This provides a time within which the host vehicle combination 302 can travel without encountering unseen obstacles. Alternatively or additionally, a longitudinal distance for the host vehicle combination 302 to travel the visible range R is determined.

At 504, a second time is determined. The second time is for the host vehicle combination 302 to perform an overtaking manoeuvre on the at least one preceding vehicle 304 in a stable manner. This provides a time within which the host vehicle combination 302 can overtake the least one preceding vehicle 304 without any instability. For example, an overtaking manoeuvre can be modelled that has a rearward amplification, a rollover risk, and/or an off-tracking below a threshold, as discussed above. Alternatively or additionally, a longitudinal distance for the host vehicle combination 302 to perform an overtaking manoeuvre on the at least one preceding vehicle 304 in a stable manner is determined.

The second time (or longitudinal distance) may comprise a time (or longitudinal distance) for the host vehicle combination 302 to make a first lateral movement beyond the width of the at least one preceding vehicle 304 (i.e. to pull out from behind the at least one preceding vehicle 304 into a target/adjacent lane). This may include a safety margin/clearance to ensure the host vehicle combination 302 is outside the preceding vehicle 304. This may be determined based on parameters 305 of the at least one preceding vehicle 304 such as one or more of a lateral velocity, a lateral acceleration, and a width of the at least one preceding vehicle 304.

The second time (or longitudinal distance) may also comprise a time (or longitudinal distance) for the host vehicle combination 302 to make a longitudinal movement past the length of the at least one preceding vehicle 304 (i.e. to drive past the at least one preceding vehicle 304). This may include a safety margin/clearance to ensure the host vehicle combination 302 is past the preceding vehicle 304. This may be determined based on parameters 305 of the at least one preceding vehicle 304 such as one or more of a longitudinal velocity, a longitudinal acceleration, and a length of the at least one preceding vehicle 304.

The second time (or longitudinal distance) may also comprise a time (or longitudinal distance) for the host vehicle combination 302 to make a second lateral movement in an opposite direction to the first lateral movement (i.e. to return to the proper lane). This may be determined based on parameters 305 of the at least one preceding vehicle 304 such as one or more of a lateral velocity, a lateral acceleration, and a width of the at least one preceding vehicle 304.

At 506, the first time is compared to the second time and, if the second time is less than the first time (i.e. the time to perform a stable overtaking manoeuvre is less that the time to travel the visible range R), then an overtaking opportunity is identified. A difference between the first and second times may also be used as a risk metric for the overtaking opportunity, where a larger difference indicates a lower risk. This enables a ranking of overtaking opportunities to be generated. In some examples, a safety factor or buffer may be included to ensure that the second time sufficiently less than the first time for a stable overtaking manoeuvre to be performed.

As also discussed above in relation to 406, a second approach to determining an overtaking opportunity involves the modelling of one or more overtaking manoeuvres within the visible range R, and determining if a stability a corresponding measure meets a threshold stability. This explained in relation to FIG. 6, which is a flow chart of a computer-implemented method 600 for determining that the host vehicle combination 302 can perform an overtaking manoeuvre over the at least one preceding vehicle 304 within the visible range R in a stable manner. The method 600 may be implemented by processing circuitry of a computer system (e.g., the processing circuitry 170 of the controller(s) 160, or the processing circuitry 190 of the global controller 180 described in relation to FIG. 1).

At 602, a stability measure of an overtaking manoeuvre is determined. The overtaking manoeuvre is to be performed by the host vehicle combination 302 within the visible range R. The stability measure provides an assessment of whether the behaviour of the host vehicle combination 302 during the overtaking manoeuvre can be considered safe and/or stable. As discussed above, the stability measure may include one or more of a rearward amplification, a rollover risk, and an off-tracking of the host vehicle combination 302.

The stability measure may be determined in the manner discussed above. For example, a measure of the rearward amplification for a trailing unit 110-2 may be defined as the ratio of the maximum absolute yaw rate or lateral acceleration of the trailing unit 110-2 to the maximum absolute yaw rate or lateral acceleration of the tractor unit 110-1 during an overtaking manoeuvre. A measure of the rollover risk for a unit 110 may be defined as the ratio of half the wheelbase of the unit 110 to the CoG height of the unit 110, and/or can be provided by measuring the lateral acceleration, roll angle, and roll rate of the unit 110 during an overtaking manoeuvre. Off-tracking can be defined as the deviation of the tractor unit 110-1 from an intended path, and/or the deviation of a trailing unit 110-2 from the path of the tractor unit 110-1.

At 604, it is determined if the stability measure is above a threshold stability and, if so, an overtaking opportunity is identified. In particular, if the determined value(s) of rearward amplification, rollover risk, and/or off-tracking are below a respective threshold, the overtaking manoeuvre can be considered stable and an overtaking opportunity is identified. The thresholds used for the respective stability measures may be dependent on parameters such as the number of trailing units 110-2, the mass of the trailing unit 110-2, the speed of the host vehicle combination 302, a type of the host vehicle combination 302, a type of coupling 140 between units 110, environmental parameters 210, and the like. In some examples, different thresholds may be set for different stages of an overtaking manoeuvre. A difference between the stability measure and its respective threshold may also be used as a risk metric for the overtaking opportunity, where a larger difference indicates a lower risk. This enables a ranking of overtaking opportunities to be generated. In some examples, a safety factor or buffer may be included to ensure that the stability measure sufficiently higher than the threshold stability for a stable overtaking manoeuvre to be performed.

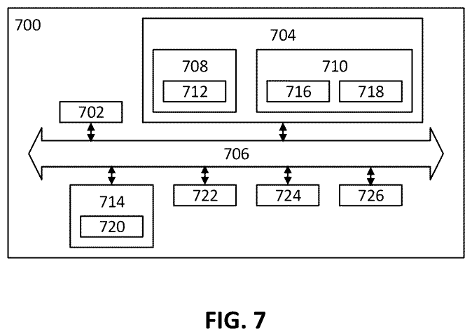

FIG. 7 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (160, 180) for identifying an overtaking opportunity for a host vehicle combination (100, 302) comprising a tractor unit (110-1) and at least one trailing unit (110-2), the computer system (160, 180) comprising processing circuitry (170, 190) configured to: acquire parameters (305) of at least one vehicle (304) preceding the host vehicle combination (100, 302); determine a visible range, R, from the host vehicle combination (100, 302) for an upcoming section (206, 300) of a route (200); and identify an overtaking opportunity by determining that the host vehicle combination (100, 302) can perform an overtaking manoeuvre over the at least one preceding vehicle (304) within the visible range, R, in a stable manner based on the acquired parameters (305) of the at least one preceding vehicle (304).

Example 2: The computer system (160, 180) of example 1, wherein the processing circuitry (170, 190) is configured to: determine a first time or longitudinal distance for the host vehicle combination (100, 302) to travel the visible range, R; determine a second time or longitudinal distance for the host vehicle combination (100, 302) to perform an overtaking manoeuvre on the at least one preceding vehicle (304) in a stable manner, based on the acquired parameters (305) of the at least one preceding vehicle (304); and determine that the second time or longitudinal distance is less than the first time or longitudinal distance.

Example 3: The computer system (160, 180) of example 2, wherein the second time or longitudinal distance comprises: a time or longitudinal distance to make a first lateral movement beyond the width of the at least one preceding vehicle (304), a time or longitudinal distance to make a longitudinal movement past the length of the at least one preceding vehicle (304), and a time or longitudinal distance to make a second lateral movement in an opposite direction to the first lateral movement.

Example 4: The computer system (160, 180) of example 1, wherein the processing circuitry (170, 190) is configured to: determine a stability measure of an overtaking manoeuvre by the host vehicle combination (100, 302) over the at least one preceding vehicle (304) within the visible range, R, based on the acquired parameters (305) of the at least one preceding vehicle (304); and determine that the stability measure is above a threshold stability.

Example 5: The computer system (160, 180) of any preceding example, wherein the parameters (305) of the at least one preceding vehicle comprise one or more of a longitudinal velocity, a longitudinal acceleration, a lateral velocity, a lateral acceleration, a length, a width, and a type of the at least one preceding vehicle (304).

Example 6: The computer system (160, 180) of any preceding example, wherein the processing circuitry (170, 190) is configured to determine that the host vehicle combination (100, 302) can perform an overtaking manoeuvre over the at least one preceding vehicle (304) within the visible range, R, in a stable manner based on at least one of one or more route parameters (205), one or more host vehicle combination parameters (105), and one or more environmental parameters (210).

Example 7: The computer system (160, 180) of any preceding example, wherein an overtaking manoeuvre performed in a stable manner comprises one or more of a rearward amplification, a rollover risk, and an off-tracking of the host vehicle combination (100, 302) being below a respective threshold value.

Example 8: The computer system (160, 180) of example 7, wherein the rearward amplification is defined as: the ratio of the maximum absolute yaw rate of a trailing unit (110-2) of the host vehicle combination (100, 302) to the maximum absolute yaw rate of a tractor unit (110-1) of the host vehicle combination (100, 302); or the ratio of the maximum absolute lateral acceleration of a trailing unit (110-2) of the host vehicle combination (100, 302) to the maximum absolute lateral acceleration of a tractor unit (110-1) of the host vehicle combination (100, 302).

Example 9: The computer system (160, 180) of any preceding example, wherein the processing circuitry (170, 190) is further configured to determine one or more control inputs for the host vehicle combination (100, 302) to perform the overtaking manoeuvre.

Example 10: The computer system (160, 180) of example 9, wherein the processing circuitry (170, 190) is further configured to: determine that a stability measure during performance of the overtaking manoeuvre by the host vehicle combination (100, 302) is below a threshold stability; and update the one or more control inputs such that stability measure is above the threshold stability.

Example 11: The computer system (160, 180) of example 9 or 10, wherein the processing circuitry (170, 190) is further configured to update the one or more control inputs during performance of the overtaking manoeuvre by the host vehicle combination (100, 302) based on updated parameters (305) of the at least one preceding vehicle.

Example 12: A vehicle ( ) comprising the computer system (160, 180) of any preceding example.

Example 13: A computer-implemented method (400) for identifying an overtaking opportunity for a host vehicle combination (100, 302) comprising a tractor unit (110-1) and at least one trailing unit (110-2), the computer-implemented method (400) comprising: acquiring (402), by processing circuitry (170, 190) of a computer system (160, 180), parameters (305) of at least one vehicle (304) preceding the host vehicle combination (100, 302); determining (404), by the processing circuitry (170, 190), a visible range, R, from the host vehicle combination (100, 302) for an upcoming section (206) of a route (200); and identifying (406), by the processing circuitry (170, 190), an overtaking opportunity by determining (500, 600) that the host vehicle combination (100, 302) can perform an overtaking manoeuvre over the at least one preceding vehicle (304) within the visible range, R, in a stable manner based on the acquired parameters (305) of the at least one preceding vehicle (304).

Example 14: The computer-implemented method (400) of example 13, comprising: determining a first time or longitudinal distance for the host vehicle combination (100, 302) to travel the visible range, R; determining a second time or longitudinal distance for the host vehicle combination (100, 302) to perform an overtaking manoeuvre on the at least one preceding vehicle (304) in a stable manner, based on the acquired parameters (305) of the at least one preceding vehicle (304); and determining that the second time or longitudinal distance is less than the first time or longitudinal distance.

Example 15: The computer-implemented method (400) of example 14, wherein the second time or longitudinal distance comprises: a time or longitudinal distance to make a first lateral movement beyond the width of the at least one preceding vehicle (304), a time or longitudinal distance to make a longitudinal movement past the length of the at least one preceding vehicle (304), and a time or longitudinal distance to make a second lateral movement in an opposite direction to the first lateral movement.

Example 16: The computer-implemented method (400) of example 13, comprising: determining a stability measure of an overtaking manoeuvre by the host vehicle combination (100, 302) over the at least one preceding vehicle (304) within the visible range, R, based on the acquired parameters (305) of the at least one preceding vehicle (304); and determining that the stability measure is above a threshold stability.

Example 17: The computer-implemented method (400) of any of examples 13 to 16, wherein the parameters (305) of the at least one preceding vehicle comprise one or more of a longitudinal velocity, a longitudinal acceleration, a lateral velocity, a lateral acceleration, a length, a width, and a type of the at least one preceding vehicle (304).

Example 18: The computer-implemented method (400) of any of examples 13 to 17, comprising determining that the host vehicle combination (100, 302) can perform an overtaking manoeuvre over the at least one preceding vehicle (304) within the visible range, R, in a stable manner based on at least one of one or more route parameters (205), one or more host vehicle combination parameters (105), and one or more environmental parameters (210).

Example 19: The computer-implemented method (400) of any of examples 13 to 18, wherein an overtaking manoeuvre performed in a stable manner comprises one or more of a rearward amplification, a rollover risk, and an off-tracking of the host vehicle combination (100, 302) being below a respective threshold value.

Example 20: The computer-implemented method (400) of example 19, wherein the rearward amplification is defined as: the ratio of the maximum absolute yaw rate of a trailing unit (110-2) of the host vehicle combination (100, 302) to the maximum absolute yaw rate of a tractor unit (110-1) of the host vehicle combination (100, 302); or the ratio of the maximum absolute lateral acceleration of a trailing unit (110-2) of the host vehicle combination (100, 302) to the maximum absolute lateral acceleration of a tractor unit (110-1) of the host vehicle combination (100, 302).

Example 21: The computer-implemented method (400) of any of examples 13 to 20, further comprising determining one or more control inputs for the host vehicle combination (100, 302) to perform the overtaking manoeuvre.

Example 22: The computer-implemented method (400) of example 21, further comprising determining that a stability measure during performance of the overtaking manoeuvre by the host vehicle combination (100, 302) is below a threshold stability; and updating the one or more control inputs such that stability measure is above the threshold stability.

Example 23: The computer-implemented method (400) of example 21 or 22, further comprising updating the one or more control inputs during performance of the overtaking manoeuvre by the host vehicle combination (100, 302) based on updated parameters (305) of the at least one preceding vehicle.

Example 24: A computer program product comprising program code for performing, when executed by processing circuitry (170, 190), the computer-implemented method (400) of any of examples 13 to 23.

Example 25: A non-transitory computer-readable storage medium comprising instructions, which when executed by processing circuitry (170, 190), cause the processing circuitry to perform the computer-implemented method (400) of any of examples 13 to 23.

Terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for identifying an overtaking opportunity for a host vehicle combination comprising a tractor unit and at least one trailing unit, the computer system comprising processing circuitry configured to:
acquire parameters of at least one vehicle preceding the host vehicle combination;
determine a visible range, R, from the host vehicle combination for an upcoming section of a route; and
identify an overtaking opportunity by determining that the host vehicle combination can perform an overtaking manoeuvre over the at least one preceding vehicle within the visible range, R, in a stable manner based on the acquired parameters of the at least one preceding vehicle.

2. The computer system of claim 1, wherein the processing circuitry is configured to:
determine a first time or longitudinal distance for the host vehicle combination to travel the visible range, R;
determine a second time or longitudinal distance for the host vehicle combination to perform an overtaking manoeuvre on the at least one preceding vehicle in a stable manner, based on the acquired parameters of the at least one preceding vehicle; and
determine that the second time or longitudinal distance is less than the first time or longitudinal distance.

3. The computer system of claim 2, wherein the second time or longitudinal distance comprises:
a time or longitudinal distance to make a first lateral movement beyond the width of the at least one preceding vehicle,
a time or longitudinal distance to make a longitudinal movement past the length of the at least one preceding vehicle, and
a time or longitudinal distance to make a second lateral movement in an opposite direction to the first lateral movement.

4. The computer system of claim 1, wherein the processing circuitry is configured to:
determine a stability measure of an overtaking manoeuvre by the host vehicle combination over the at least one preceding vehicle within the visible range, R, based on the acquired parameters of the at least one preceding vehicle; and
determine that the stability measure is above a threshold stability.

5. The computer system of claim 1, wherein the parameters of the at least one preceding vehicle comprise one or more of a longitudinal velocity, a longitudinal acceleration, a lateral velocity, a lateral acceleration, a length, a width, and a type of the at least one preceding vehicle.

6. The computer system of claim 1, wherein the processing circuitry is configured to determine that the host vehicle combination can perform an overtaking manoeuvre over the at least one preceding vehicle within the visible range, R, in a stable manner based on at least one of one or more route parameters, one or more host vehicle combination parameters, and one or more environmental parameters.

7. The computer system of claim 1, wherein an overtaking manoeuvre performed in a stable manner comprises one or more of a rearward amplification, a rollover risk, and an off-tracking of the host vehicle combination being below a respective threshold value.

8. The computer system of claim 7, wherein the rearward amplification is defined as:
the ratio of the maximum absolute yaw rate of a trailing unit of the host vehicle combination to the maximum absolute yaw rate of a tractor unit of the host vehicle combination; or
the ratio of the maximum absolute lateral acceleration of a trailing unit of the host vehicle combination to the maximum absolute lateral acceleration of a tractor unit of the host vehicle combination.

9. The computer system of claim 1, wherein the processing circuitry is further configured to determine one or more control inputs for the host vehicle combination to perform the overtaking manoeuvre.

10. The computer system of claim 9, wherein the processing circuitry is further configured to:
determine that a stability measure during performance of the overtaking manoeuvre by the host vehicle combination is below a threshold stability; and
update the one or more control inputs such that stability measure is above the threshold stability.

11. The computer system of claim 9, wherein the processing circuitry is further configured to update the one or more control inputs during performance of the overtaking manoeuvre by the host vehicle combination based on updated parameters of the at least one preceding vehicle.

12. A vehicle comprising the computer system of claim 1.

13. A computer-implemented method for identifying an overtaking opportunity for a host vehicle combination comprising a tractor unit and at least one trailing unit, the computer-implemented method comprising:
acquiring, by processing circuitry of a computer system, parameters of at least one vehicle preceding the host vehicle combination;
determining, by the processing circuitry, a visible range, R, from the host vehicle combination for an upcoming section of a route; and
identifying, by the processing circuitry, an overtaking opportunity by determining that the host vehicle combination can perform an overtaking manoeuvre over the at least one preceding vehicle within the visible range, R, in a stable manner based on the acquired parameters of the at least one preceding vehicle.

14. The computer-implemented method of claim 13, comprising: determining a first time or longitudinal distance for the host vehicle combination to travel the visible range, R; determining a second time or longitudinal distance for the host vehicle combination to perform an overtaking manoeuvre on the at least one preceding vehicle in a stable manner, based on the acquired parameters of the at least one preceding vehicle; and determining that the second time or longitudinal distance is less than the first time or longitudinal distance.

15. The computer-implemented method of claim 14, wherein the second time or longitudinal distance comprises: a time or longitudinal distance to make a first lateral movement beyond the width of the at least one preceding vehicle, a time or longitudinal distance to make a longitudinal movement past the length of the at least one preceding vehicle, and a time or longitudinal distance to make a second lateral movement in an opposite direction to the first lateral movement.

16. The computer-implemented method of claim 13, comprising: determining a stability measure of an overtaking manoeuvre by the host vehicle combination over the at least one preceding vehicle within the visible range, R, based on the acquired parameters of the at least one preceding vehicle; and determining that the stability measure is above a threshold stability.

17. The computer-implemented method of claim 13, wherein the parameters of the at least one preceding vehicle comprise one or more of a longitudinal velocity, a longitudinal acceleration, a lateral velocity, a lateral acceleration, a length, a width, and a type of the at least one preceding vehicle.

18. The computer-implemented method of claim 13, further comprising determining one or more control inputs for the host vehicle combination to perform the overtaking manoeuvre.

19. A computer program product comprising program code for performing, when executed by processing circuitry, the computer-implemented method of claim 13.

20. A non-transitory computer-readable storage medium comprising instructions, which when executed by processing circuitry, cause the processing circuitry to perform the computer-implemented method of claim 13.
